(19) United States
(12) Patent Application Publication
(10) Pub. No.: US 2011/0038334 A1
(43) Pub. Date: Feb. 17, 2011

(54) METHOD AND APPARATUS FOR SEMI-PERSISTENT SCHEDULING FOR MULTIPLE UPLINK VOIP CONNECTIONS

(75) Inventors: Xiaolong Huang, San Diego, CA (US); Saiyiu D. Ho, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/854,519

(22) Filed: Aug. 11, 2010

Related U.S. Application Data
(60) Provisional application No. 61/233,460, filed on Aug. 12, 2009.

(51) Int. Cl. H04W 4/00; H04B 7/00; H04L 12/56

(52) U.S. Cl. 370/329; 370/310; 370/389

(57) ABSTRACT

Semi-Persistent Scheduling (SPS) addresses a variable number of sessions between nodes, such as an SPS operation applied on a radio bearer between a Remote evolved Base Node (ReNB) and a Donor evolved Base Node (DeNB). As the number of VoIP connections changes over time, the upper bound of the required uplink grant size also changes. Even if the number of VoIP connections is assumed to be fixed over a period of time, the superposition of “on” and “off” intervals of multiple VoIP calls will require the uplink grant size to change over time much more dynamically. Using a fixed uplink SPS size based on a fixed number of VoIP calls will result in inefficient use of uplink grants, (i.e., reserving more grants than needed) or Physical Downlink Control Channel (PDCCH) signaling overhead for VoIP packets that cannot be served by SPS. A set of solutions are provided for semi-persistently scheduling multiple VoIP connections between a ReNB and a DeNB so as to enhance efficient use of SPS and still meet Quality of Service (QoS) requirement(s) of VoIP traffic.

### CROSS-REFERENCE

This application claims the benefit of U.S. Provisional Application Ser. No. 61/233,460, filed Aug. 12, 2009, entitled “SEMI-PERSISTENT SCHEDULING FOR MULTIPLE UPLINK VoIP CONNECTIONS,” and assigned to the assignee hereof and the entirety of which is incorporated herein by reference.

### BACKGROUND

### Field

The subject disclosure pertains to wireless communication systems, and in particular to semi-persistent scheduling in a wireless communication network.

Wireless communication systems are widely deployed to provide various communication content such as for example voice, video, packet data, messaging, broadcast, etc. These wireless systems may be multiple-access systems capable of supporting multiple users by sharing available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

Generally, a wireless multiple-access communication system can concurrently support communication for multiple wireless terminals. Each terminal communicates with one or more base stations via transmissions on forward and reverse links. The forward link (or downlink) refers to a communication link from base stations to terminals, and the reverse link (or uplink) refers to a communication link from terminals to base stations. This communication link can be established via a single-in-single-out, multiple-in-signal-out, or a multiple-in-multiple-out (MIMO) system.

The 3rd Generation Partnership Project (3GPP) Long Term Evolution (LTE) represents a major advance in cellular technology and is the next step forward in cellular 3G services as a natural evolution of Global system for mobile communications (GSM) and Universal Mobile Telecommunications System (UMTS). LTE provides for an uplink speed of up to 50 megabits per second (Mbps) and a downlink speed of up to 100 Mbps and brings many technical benefits to cellular networks. LTE is designed to meet carrier needs for high-speed data and media transport as well as high-capacity voice support well into the next decade. Bandwidth is scalable from 1.25 MHz to 20 MHz. This suits the needs of different network operators that have different bandwidth allocations, and also allows operators to provide different services based on spectrum. LTE is also expected to improve spectral efficiency in 3G networks, allowing carriers to provide more data and voice services over a given bandwidth. LTE encompasses high-speed data, multimedia unicast and multimedia broadcast services.

The LTE physical layer (PHY) is a highly efficient means of conveying both data and control information between an enhanced base station (eNodeB) and mobile user equipment (UE). The LTE PHY employs some advanced technologies that are new to cellular applications. These include Orthogonal Frequency Division Multiplexing (OFDM) and Multiple Input Multiple Output (MIMO) data transmission. In addition, the LTE PHY uses Orthogonal Frequency Division Multiple Access (OFDMA) on the downlink (DL) and Single Carrier-Frequency Division Multiple Access (SC-FDMA) on the uplink (UL). OFDMA allows data to be directed to or from multiple users on a subcarrier-by-subcarrier basis for a specified number of symbol periods.

A wireless system base station can communicate with several user equipment (UE). Each UE may comprise different release versions (e.g., Rel-8, Rel-9, Rel-10, or beyond) and capabilities (e.g., MIMO or SIMO). Each release version is typically associated with a particular specification comprising a set of requirements. A UE can be identified as being a Rel-8, Rel-9, Rel-10 or any suitable future release, user equipment. Each release generally has more capabilities than a previous version. As will be discussed in greater detail below, traditional semi-persistent scheduling (SPS) operation will not work well for LTE with relay.

In Rel-8, the system employs a semi-persistent scheduling (SPS) operation designed to support a single uplink Voice over IP (VoIP) connection between a user equipment (UE) and an evolved NodeB (eNB). The SPS operation provides periodic grants for an uplink VoIP connection to match its packet arrival pattern. In this manner, VoIP packets can be served with minimum control overhead, while not violating delay requirements. The SPS operation can also switch the periodic grants on and off to match the VoIP activity's on and off intervals, so that a multiplexing gain can be achieved to increase VoIP capacity when multiple VoIP connections are served by an eNB. The standard SPS operation is well suited for serving a single uplink VoIP connection. The SPS operation includes the following procedures:

SPS configuration: When a VoIP call arrives or is experiencing a handover, a UE will go through a Radio Resource Control (RRC) connection setup or RRC connection reestablishment procedure, respectively. In these two procedures, RRC messages are sent by the eNB to the UE to specify the attributes of the radio bearers. A “RadioResourceConfigDedicated” IE is included in these RRC messages. The IE can include an SPS-Configuration field that specifies the semi-persistent scheduling parameters. One parameter is “SemiPersistSchedIntervalUL”, which specifies the periodic time interval in number of sub-frames between two consecutive uplink grants. Another parameter is “implicitReleaseAfter”, which specifies the number of empty transmissions before the SPS service is implicitly released.

Switch on periodic uplink grants: When the VoIP activity transitions from “off” to “on”, the UE sends a Scheduling Request (SR) to eNB via Physical Downlink Control Channel (PDCCH). Upon the reception of an SR, eNB starts to periodically provide uplink grants to the UE once every SemiPersistSchedIntervalUL number of sub-frames.

Switch off periodic uplink grants: When the VoIP activity transitions from “on” to “off”, UE does not have VoIP packets to transmit, which will result in implicitReleaseAfter number of empty SPS transmissions. Subsequently, eNB stops providing periodic uplink grants.

Currently, Rel-10 (e.g. Long Term Evolution-Advance) is planning to utilize cell relays to expand network capacity and coverage area by facilitating communication between mobile devices and access points. For example, a cell relay can establish a backhaul link with a donor access point, which can provide access to a number of cell relays, and the cell relay can establish an access link with one or more mobile devices or additional cell relays. In Rel-10 system, multiple uplink VoIP connections can be established using relay access points. If the same SPS operation is used as in older releases, there would be excess amounts of grants which will make the system inefficient. Thus, it may be desirable to provide enhanced SPS operation between the donor access point and relay access point to manage uplink grants for multiple VoIP connections.

### SUMMARY

The following presents a simplified summary in order to provide a basic understanding of some aspects of the disclosed aspects. This summary is not an extensive overview, and is intended to neither identify key or critical elements nor delineate the scope of such aspects. Its purpose is to present some concepts of the described features in a simplified form as a prelude to the more detailed description that is presented later.

In accordance with one or more aspects and corresponding disclosure thereof, various aspects are described in connection with providing an enhanced SPS operation to reduce number of grants required for a wireless communication system. Various aspects are described in connection with dynamically changing Semi-Persistent Scheduling (SPS) to address a variable number of sessions between nodes, such as an SPS operation applied on a radio bearer between a Remote evolved Base Node (ReNB) and a Donor evolved Base Node (DeNB). In Long Term Evolution Advance (LTE-A), multiple uplink VoIP connections need to be served between ReNB and a DeNB over the Un interface. As the number of VoIP connections changes over time, the upper bound of the required uplink grant size also changes. Therefore, a fixed uplink grant size employed by the conventional SPS cannot serve the purpose. Even if the number of VoIP connections is assumed to be fixed over a period of time, the superposition of “on” and “off” intervals of multiple VoIP calls will require the uplink grant size to change over time much more dynamically. Using a fixed uplink SPS size based on a fixed number of VoIP calls will result in inefficient use of uplink grants, (e.g., reserving more grants than needed) or Physical Downlink Control Channel (PDCCH) signaling overhead for VoIP packets that cannot be served by SPS. In this disclosure, a set of solutions are introduced for semi-persistently scheduling multiple VoIP connections between a ReNB and a DeNB. These solutions can significantly enhance the efficient use of SPS and still meet Quality of Service (QoS) requirement(s) of VoIP traffic.

In accordance with an aspect, an apparatus operable in a wireless communication system comprises: means for determining number of VoIP connections; means for determining if data rate for the VoIP connections are not the same; and means for transmitting upper bounds of uplink grants required if the data rate for the VoIP connections are not the same.

In accordance with another aspect, a method for adjusting semi-persistent scheduling (SPS) for Voice over Internet Protocol (VoIP); comprises: determining number of VoIP connections; determining if data rate for the VoIP connections are not the same; and transmitting upper bounds of uplink grants required if the data rate for the VoIP connections are not the same.

In yet another aspect, a computer program product for adjusting semi-persistent scheduling (SPS) for Voice over Internet Protocol (VoIP) comprises: at least one computer readable storage medium storing computer executable instructions that, when executed by at least one processor, implement components that effect the following acts: determine number of VoIP connections; determine if data rate for the VoIP connections are not the same; and transmit upper bounds of uplink grants required if the data rate for the VoIP connections are not the same.

In another aspect, an apparatus operable in a wireless communication system, the apparatus comprises: means for determining desired SPS uplink grant size; means for transmitting, periodically, the desired SPS uplink grant size; means for monitoring number of VoIP calls and connections; means for determining if conditions have changed that would require a change in current uplink grant size requirement; and means for transmitting a new SPS uplink grant size prior to end of period.

In still another aspect, a method for adjusting semi-persistent scheduling (SPS) for Voice over Internet Protocol (VoIP); comprises: determining desired SPS uplink grant size; transmitting, periodically, the desired SPS uplink grant size; monitoring number of VoIP calls and connections; determining if conditions have changed that would require a change in current uplink grant size requirement; and transmitting a new SPS uplink grant size prior to end of period.

In accordance with an aspect, a computer program product for adjusting semi-persistent scheduling (SPS) for Voice over Internet Protocol (VoIP); comprises: at least one computer readable storage medium storing computer executable instructions that, when executed by at least one processor, implement components that effect the following acts: determine desired SPS uplink grant size; transmit, periodically, the desired SPS uplink grant size; monitor number of VoIP calls and connections; determine if conditions have changed that would require a change in current uplink grant size requirement; and transmit a new SPS uplink grant size prior to end of period.

In yet another aspect, an apparatus operable in a wireless communication system, the apparatus comprises: means for determining desired SPS uplink grant size; means for determining if data rate for the VoIP connections are not the same; and means for transmitting the desired SPS uplink grant size if determined that data rate for the VoIP connections are not the same.

In another aspect, an apparatus operable in a wireless communication system, the apparatus comprising: means for receiving number of VoIP connections; means for receiving upper bounds of uplink grants required; and means for determining a fixed upper uplink grant size.

In still yet another aspect, a method for dynamically adjusting semi-persistent scheduling (SPS) for Voice over Internet Protocol (VoIP); comprises: employing a processor executing computer executable instructions stored on a computer readable storage medium to implement following acts: relaying a plurality of VoIP connections over an uplink channel; determining change in the plurality of VoIP connections; and adjusting an uplink grant for the plurality of VoIP connections.

In an aspect, a computer program product for dynamically adjusting of semi-persistent scheduling (SPS) for Voice over Internet Protocol (VoIP); comprises: at least one computer readable storage medium storing computer executable instructions that, when executed by at least one processor, implement components comprising: a first set of codes for relaying a plurality of VoIP connections over an uplink channel; a second set of codes for determining a change in the plurality of VoIP connections; and a third set of codes for adjusting an uplink grant for the plurality of VoIP connections.

In accordance with another aspect, an apparatus for dynamically adjusting of semi-persistent scheduling (SPS) for Voice over Internet Protocol (VoIP); comprises: at least one processor; at least one computer readable storage medium storing computer executable instructions that, when executed by the at least one processor, implement components comprising: means for relaying a plurality of VoIP connections over an uplink channel; means for determining a change in the plurality of VoIP connections; and means for adjusting an uplink grant for the plurality of VoIP connections.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to one embodiment;

FIG. 2 illustrates a block diagram of a communication system;

FIG. 3 illustrates a graphical plot of a steady state Cumulative Density Function (CDF) of the number of VoIP calls that are at the “on” state for a 3.0 second window;

FIG. 4 illustrates a graphical plot of a steady state Cumulative Density Function (CDF) of the number of VoIP calls that are at the “on” state for a 5.0 second window;

FIGS. 5-6 illustrate state Cumulative Density Functions (CDFs) respectively of number of VoIP calls that are at the “on” state within an observation window, assuming presence of a fixed number of VoIP connections;

FIG. 7 illustrates a wireless communication system according to Long Term Evolution Advance (LTE-A) that facilitates providing relay functionality in wireless networks;

FIG. 8 illustrates an example methodology that provides a solution for managing uplink grants of SPS operation for multiple VoIP connection;

FIG. 9 illustrates an example methodology that provides a solution for managing uplink grants of SPS operation for multiple VoIP connection;

FIG. 10 illustrates an example methodology that provides a solution for managing uplink grants of SPS operation for multiple VoIP connection;

FIG. 11 illustrates an example methodology that provides a solution according to another aspect for managing uplink grants of SPS operation for multiple VoIP connection;

FIG. 12 illustrates an example methodology that provides a solution according to another aspect for managing uplink grants of SPS operation for multiple VoIP connection;

FIG. 13 illustrates an example methodology that provides a solution according to another aspect for managing uplink grants of SPS operation for multiple VoIP connection;

FIG. 14 illustrates an example system dynamically adjusting SPS for VoIP;

FIG. 15 illustrates an example system dynamically adjusting SPS for VoIP;

FIG. 16 illustrates an example system dynamically adjusting SPS for VoIP; and

FIG. 17 illustrates an example system dynamically adjusting SPS for VoIP.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station can be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The word “exemplary” is used herein to mean serving as an example, instance, or illustration. Any aspect or design described herein as “exemplary” is not necessarily to be construed as preferred or advantageous over other aspects or designs.

Additionally, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

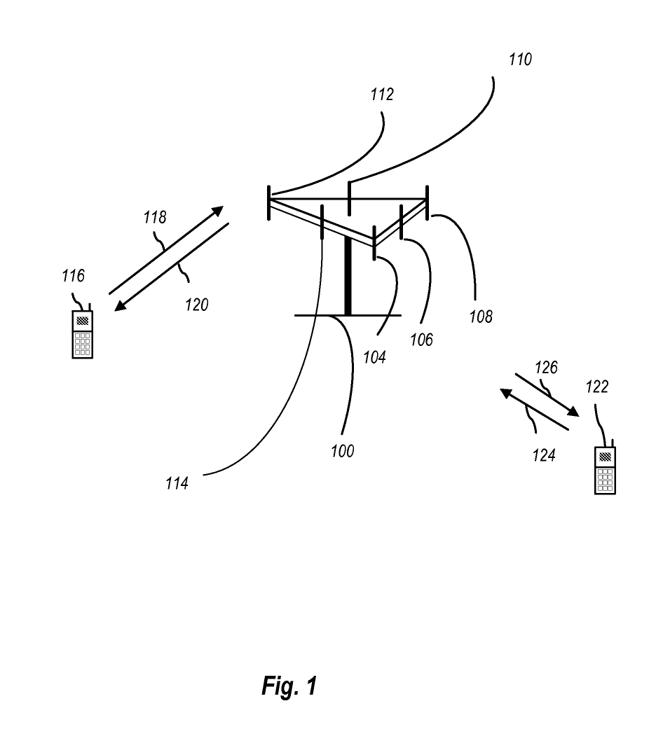

Referring now to FIG. 1, an illustration of a wireless multiple-access communication system is provided in accordance with various aspects. In one example, an access point 100 (AP) includes multiple antenna groups. As illustrated in FIG. 1, one antenna group can include antennas 104 and 106, another can include antennas 108 and 110, and another can include antennas 112 and 114. While only two antennas are shown in FIG. 1 for each antenna group, it should be appreciated that more or fewer antennas may be utilized for each antenna group. In another example, an access terminal 116 can be in communication with antennas 112 and 114, where antennas 112 and 114 transmit information to access terminal 116 over forward link 120 and receive information from access terminal 116 over reverse link 118. Additionally and/or alternatively, access terminal 122 can be in communication with antennas 106 and 108, where antennas 106 and 108 transmit information to access terminal 122 over forward link 126 and receive information from access terminal 122 over reverse link 124. In a frequency division duplex system, communication links 118, 120, 124 and 126 can use different frequency for communication. For example, forward link 120 may use a different frequency then that used by reverse link 118.

Each group of antennas and/or the area in which they are designed to communicate can be referred to as a sector of the access point. In accordance with one aspect, antenna groups can be designed to communicate to access terminals in a sector of areas covered by access point 100. In communication over forward links 120 and 126, the transmitting antennas of access point 100 can utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point, e.g., access point 100, can be a fixed station used for communicating with terminals and can also be referred to as a base station, a Node B, an access network, and/or other suitable terminology. In addition, an access terminal, e.g., an access terminal 116 or 122, can also be referred to as a mobile terminal, user equipment, a wireless communication device, a terminal, a wireless terminal, and/or other appropriate terminology.

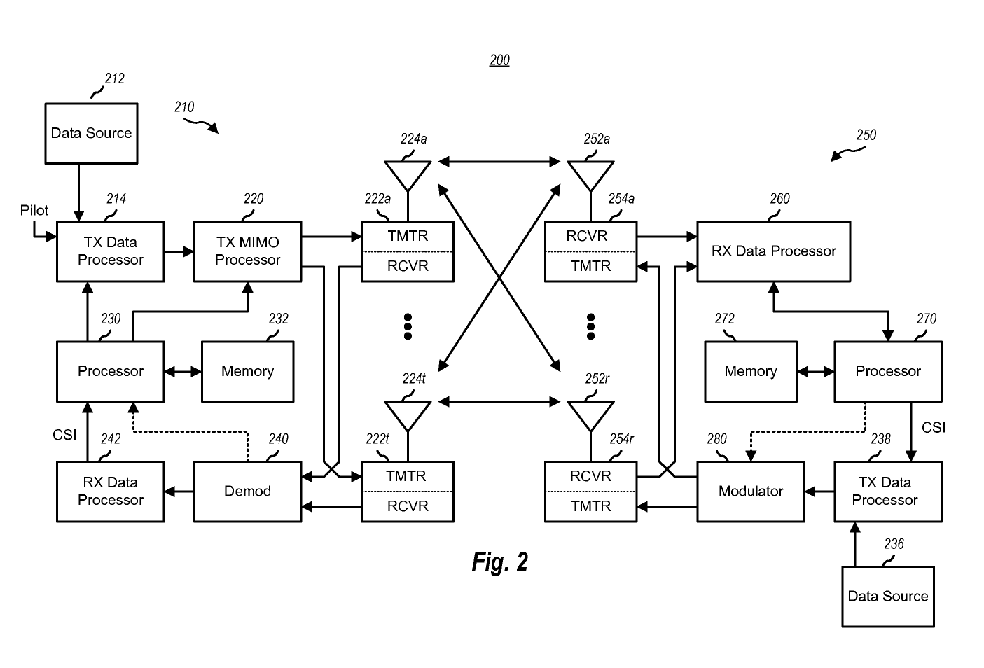

FIG. 2 is a block diagram of an embodiment of a transmitter system 210 (also known as the access point, base station and eNodeB) and a receiver system 250 (also known as access terminal and user equipment) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

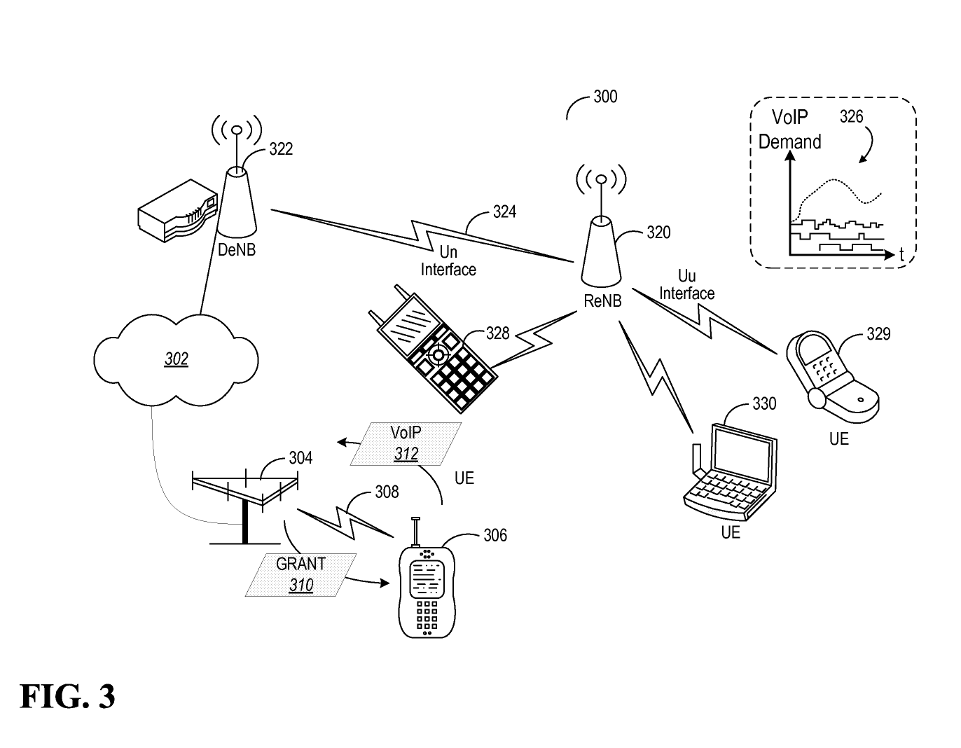

In FIG. 3, a communication system 300 includes a network 302 that has an evolved Base Node (eNB) 304 that performs fixed Semi-Persistent Scheduling (SPS) operation with a legacy User Equipment (UE) 306 in order to support a single uplink Voice over IP (VoIP) connection over a Un interface 308. The SPS operation entails the legacy eNB 304 providing periodic grants 310 on a downlink for an uplink VoIP connection 312 to match its packet arrival pattern. In this manner, VoIP packets can be served with minimum control overhead, while their delay requirements are not violated. The SPS operation can also switch the periodic grants on and off to match the on and off intervals of the VoIP activity. Thereby, a multiplexing gain can be achieved to increase VoIP capacity when multiple VoIP connections are served by the eNB 304. The standard SPS operation is well suited for serving a single uplink VoIP connection. However, such operation may not be well suited as applied on a radio bearer between a Remote eNB (ReNB) and a Donor eNB (DeNB).

An air link between a ReNB and a DeNB (e.g., the Un interface) should be able to serve multiple VoIP connections. As the number of VoIP connections changes over time, an upper bound of required uplink grant size also changes. Therefore, a fixed uplink grant size employed by a standard SPS cannot properly serve its intended purpose. Even if the number of VoIP connections is assumed to be fixed over a period of time, the superposition of “on” and “off” intervals of multiple VoIP calls will require the uplink grant size to change over time much more dynamically. Using a fixed uplink SPS size based on a fixed number of VoIP calls will result in inefficient use of uplink grants, (e.g., reserving more grants than needed) or Physical Uplink Control Channel (PDCCH) signaling overhead for VoIP packets that cannot be served by SPS.

With continued reference to FIG. 3, the communication system 300 can also provide for support for multiple VoIP usage between donor and remote nodes with more dynamic variation. In Long Term Evolution Advance (LTE-A), multiple uplink VoIP connections need to be served between a Remote eNB (ReNB) 320 and a Donor eNB (DeNB) 322 over an Un interface 324. If the same SPS operation is employed on the Un interface 324 to serve multiple uplink VoIP connections 326 to serve User Equipment (UE) 328-330, such an operation either allocates an excessive amount of uplink grants that cannot be used efficiently or allocates an inadequate amount of uplink grants that cannot be used to serve VoIP packets in time. Hence, a new SPS operation needs to be designed to replace the standard SPS operation in 3GPP Release 8. In this disclosure, a set of solutions are introduced for semi-persistently scheduling multiple VoIP connections between a ReNB and a DeNB. These solutions can significantly enhance the efficient use of SPS and still meet Quality of Service (QoS) requirement(s) of VoIP traffic.

A set of alternatives provides efficient semi-persistently scheduling for uplink VoIP connections between a ReNB and a DeNB.

Alternative A: The ReNB informs the DeNB the number of uplink VoIP connections upon a VoIP call setup and release. The DeNB uses this information to determine the fixed SPS uplink grant size based on a certain trade-off between the desired uplink grant efficiency level and the desired PDCCH signaling overhead for VoIP packets not served by SPS.

Alternative B: The ReNB informs the DeNB the current required SPS uplink grant size, or equivalently, if the data rates of different VoIP connections are the same, the number of uplink VoIP connections that are “on”. The DeNB provides the ReNB the required SPS uplink grant size advertised by the ReNB.

Alternative C: The ReNB determines a desired SPS uplink grant size, or equivalently, if the data rates of different VoIP connections are the same, a desired number of uplink VoIP connections to be accommodated concurrently at “on” state. Upon receiving such feedback, the DeNB sets the periodic SPS uplink grants size to the amount indicated in the feedback. The number of uplink VoIP connections served by the ReNB and the upper bound of the uplink grants or the change on the upper bound of uplink grants can be specified by a new Radio Resource Control (RRC) Information Element (IE), SPSFeedback IE. The current required SPS uplink grant size, or equivalently the number of uplink VoIP connections that are at the on state, and the desired SPS uplink grant size, or equivalently the number of uplink VoIP connections to be accommodated concurrently at their “on” state can be specified in any of the following IEs or messages: a) a modified Buffer Status Report (BSR), b) a new SPS Medium Access Control (MAC) Control Element (CE). The DeNB can advertise the minimum time interval allowed between two consecutive feedbacks in an additional field in the “RadioResourceConfigDedicated IE”.

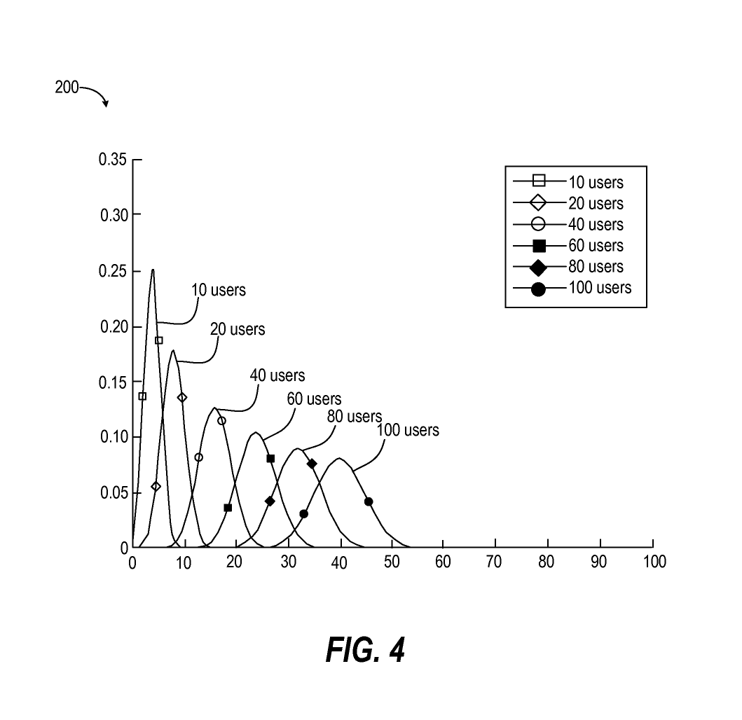

In FIG. 4, steady state PDF curves 400 are provided of number of VoIP calls that are at the “on” state. The curves 400 in FIG. 4 clearly show that using a fixed SPS size will result in either inefficient use of uplink grants or PDCCH signaling overhead for VoIP packets that are not served by SPS. The uplink grant size that is scheduled periodically over a period of time for the aggregate traffic of multiple VoIP connections has significant impact on performance of SPS.

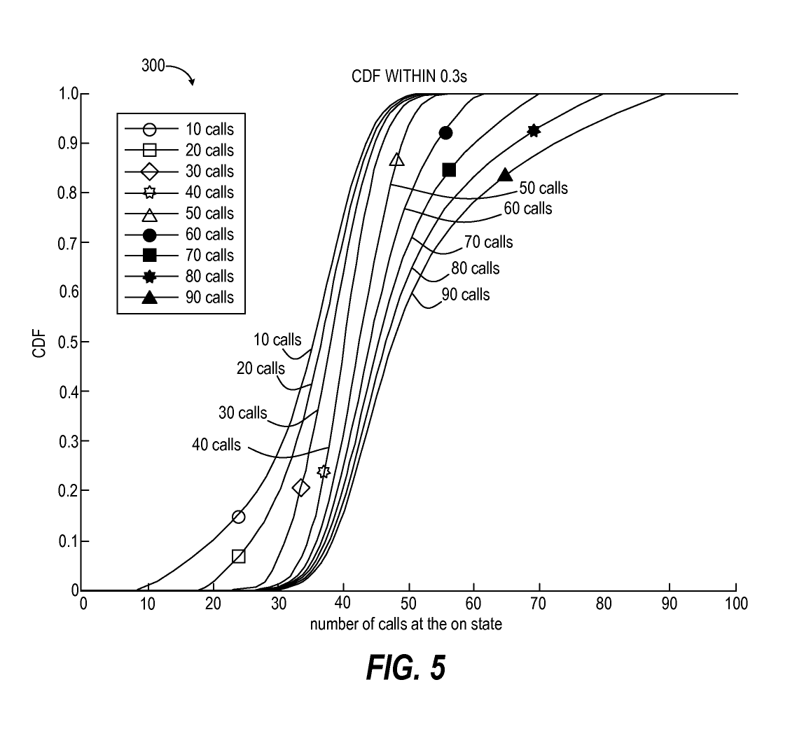

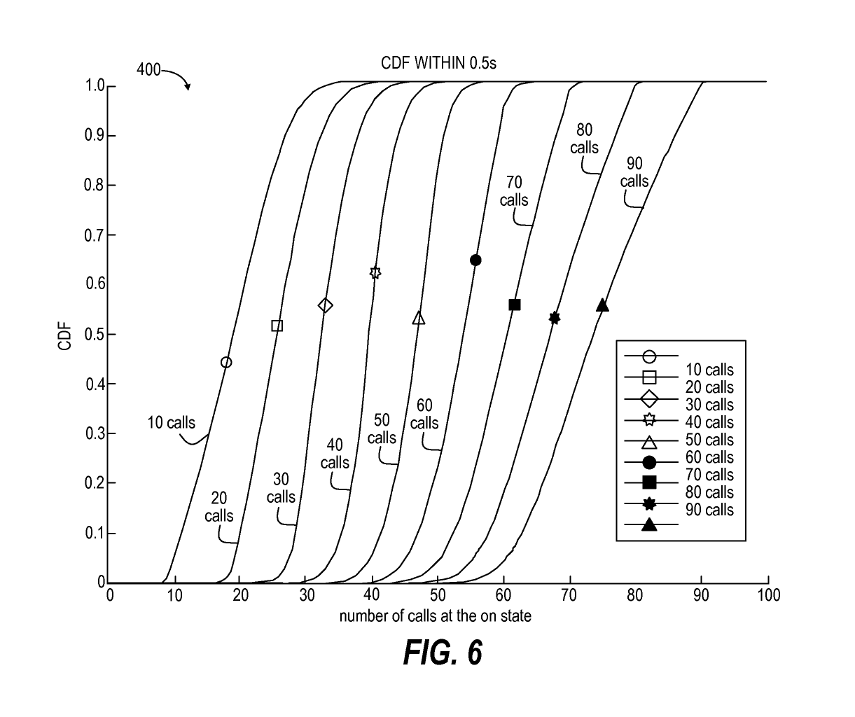

To illustrate this phenomenon, in FIGS. 5-6 transient state Cumulative Density Functions (CDFs) 500, 600, respectively of number of VoIP calls that are at the “on” state within an observation window, assuming presence of a fixed number of VoIP connections. One set of curves 500 (FIG. 5) are plotted under a 3.0 second window. Another set of curves 600 (FIG. 6) are plotted under a 0.5 second window. Each curve 500, 600 represents the CDF under a number of VoIP connections. The Y-axis represents the probability that the number of VoIP connections that are at the “on” state is less than the corresponding value on the X-axis.

The curves 500, 600 clearly show that, since state transitions are less likely to happen within a shorter period of time, the transient state distribution is closer to the initial state of the observation window. As the observation window increases, the transient state distribution becomes closer to the steady state distribution. This observation is significant, since if, by any means, the SPS uplink grant size can be adjusted more frequently, better utilization of the uplink grant and a lower PDCCH signaling overhead can be achieved for VoIP packets that are not served by SPS.

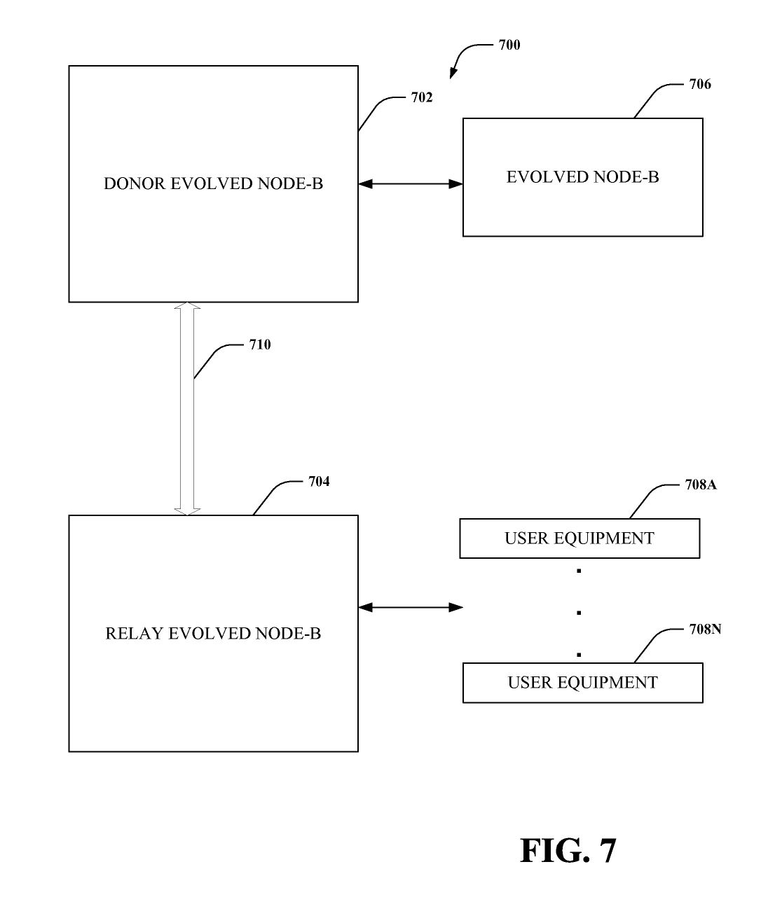

Referring to FIG. 7, a wireless communication system 700 according to Long Term Evolution Advance (LTE-A), is illustrated that facilitates providing relay functionality in wireless networks. The communication system comprises at least one DeNB 702 and at least one ReNB 704. The DeNB 702 is in communication with a standard eNB 706 (similar to access point 210). The ReNB 704 is in communication with one or more user equipment 708A-N (similar to UE 250). The ReNB 704 communicates with DeNB 702 via new interface 710 (e.g., Un interface). According to an aspect, Un interface provides capabilities for utilizing an extended SPS operation for handling VoIP calls for multiple VoIP connection. The uplink grants are provided by the eNB 706 based on SPS function employed. For multiple VoIP call, several uplink grants are required to be processed. The Un interface 710 is employed by ReNB 704 and DeNB 702 to manage the number of grants that require processing.

The Un interface 710 can also be utilized to provide feedback information from ReNB 704 to DeNB 702. According to an aspect, one or more of the following may be provided to DeNB 702: the number of uplink VoIP connections served by the ReNB 704; the upper bound of the uplink grants or the change on the upper bound of uplink grants; the current required SPS uplink grant size, or the number of uplink VoIP connection that are at the “on” state served by ReNB; or desired SPS uplink grant size or a desired number of uplink VoIP connection to be accommodated concurrently at their “on” state.

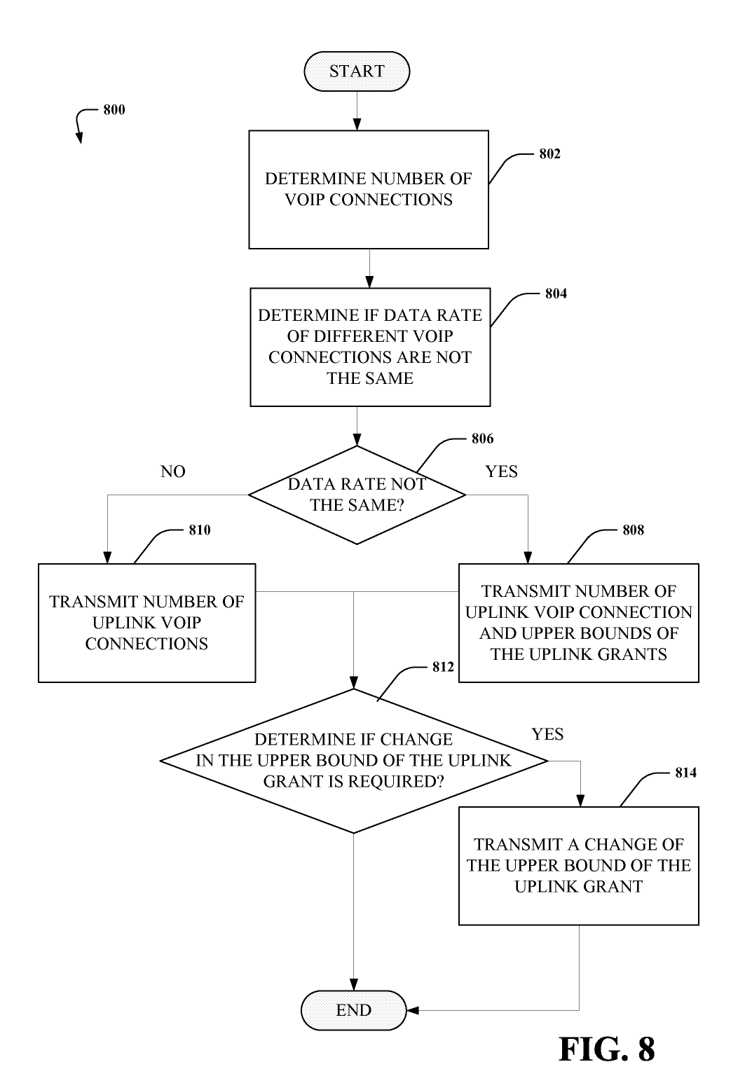

Referring to FIGS. 8-13, methodologies relating to enhanced SPS operation for managing uplink grants are disclosed. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

Referring to FIG. 8, a methodology 800 provides a solution for managing uplink grants of SPS operation for multiple VoIP connection. In block 802, the ReNB 704 determines number of VoIP connection being supported. A connection is made for each UE requiring a VoIP communication. The ReNB 704 can maintain this value in memory and update it as new connections are made or released. In block 804, the ReNB 704 determines if data rate of different VoIP connection are not the same. If at 806 it is determined that the data rates are different, at 808 the ReNB 704 will notify DeNB 702 the number of uplink VoIP connections and upper bound of the uplink grants based on number of connection. Otherwise, at block 810, the ReNB 704 will notify DeNB 702 the number of uplink VoIP connections. This notification can occur using the Un Interface or other wireless or backhaul mechanism. During the operation, the ReNB 704 will make a determination at 812 if a change in number of grants is required and determines the upper bound of the uplink grant size. If a change is required, at 814 the ReNB 704 will notify DeNB 702 by requesting a change of upper bound the uplink grant. The number of times this can change can be processed may be dictated by the DeNB 702 statically or dynamically using PDCCH. The methodology 800 may be executed either at setup or at release. In another aspect, every time a connection is added or released, ReNB 704 may send an increment or decrement value and not send the absolute value until ReNB 704 and DeNB 702 are out of sync. If out of sync, ReNB 704 can determine the number connection and transmit the absolute value to DeNB 702.

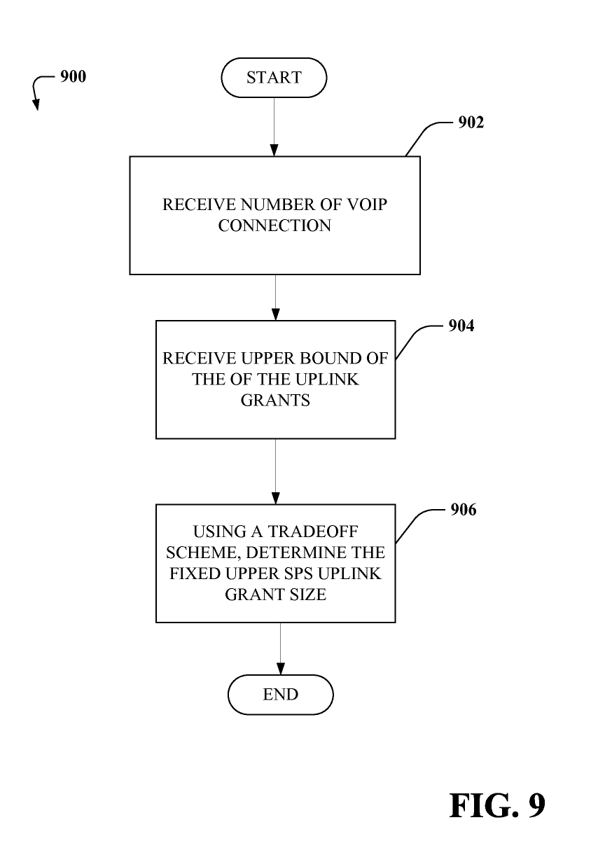

Referring to FIG. 9, a methodology 900 provides a solution for managing uplink grants of SPS operation for multiple VoIP connection. In block 902, DeNB 702 receives number of VoIP connection from ReNB 704. If the data rates are different for each connection, then at block 904, DeNB 702 also receives upper bound of the uplink grant. In block 906, using a tradeoff scheme, the DeNB 702 determines a fixed upper SPS uplink grant size to use. In one aspect, the tradeoff scheme can use the following equation to determine the upper SPS uplink grant size:

$${π}_{i} = {{π}_{0} ( \frac{λ}{μ} )}^{i} {\prod }_{j = 1}^{i} ( \frac{N - j + 1}{j} ) , i = 1 , 2 , … N$$

$${π}_{0} = 1 / ( 1 + {\sum }_{i = 1}^{N} {( \frac{λ}{μ} )}^{i} {\prod }_{j = 1}^{i} ( \frac{N - j + 1}{j} ) )$$

where πᵢ, i=0, 1, . . . , N, denotes the steady state probability that the number of uplink VoIP connections are at the on state is equal to i; N denotes the number of VoIP connections; 1/λ denotes the average duration of an “off” interval for a VoIP activity; 1/μ denotes the average duration of an “on” interval for a VoIP activity.

The DeNB 702 can set the SPS size to the data rate of a VoIP connection times a targeted number of “on” state VoIP connections, where the probability that the number of “on” state VoIP connections at any moment in time is larger than that targeted number is less than a certain value. When the data rates of different VoIP connections are not the same, the DeNB 702 can set the SPS size to be equal to the targeted number of “on” state VoIP connections times the average SPS size required by one VoIP connection among all established VoIP connections.

Since the DeNB 702 is unaware of the “on/off” state of the uplink VoIP connections, the SPS size can only vary when the number of uplink VoIP connections changes. Although using such a slowly varying SPS size based on the call arrival and departure will perform better than a fixed SPS size, the uplink grant efficiency level may be quite low while the PDCCH signaling overhead for unserved VoIP packets may be quite high.

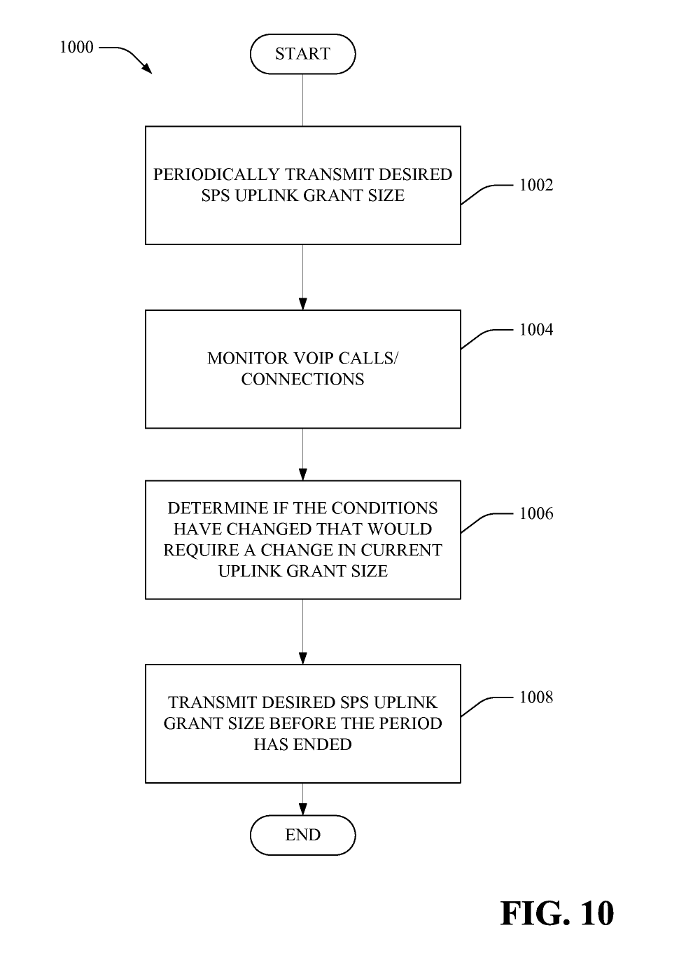

Referring to FIG. 10, a methodology 1000 provides a solution according to another aspect for managing uplink grants of SPS operation for multiple VoIP connection. In block 1002, periodically ReNB 704 transmits desired SPS uplink grant size. In this aspect, the DeNB 702 is not required to calculate SPS uplink grant size, the ReNB 704 can make the determination based on number of VoIP connections it is supporting. The uplink grant size may be predetermined based on various factors, for example, geographical location, time of day or day of the week. These factors provide a probability of VoIP connections made at ReNB 704. The ReNB 704 provides this request periodically. However, in some instances an update should be sent before the period has expired such as for example, when several new connections have been added during a period. At block 1004, the ReNB 704 monitors VoIP calls and number of connections. In block 1006, ReNB 704 determines if change in conditions would require a change in current uplink SPS grant size. The change in condition can be for example: (a) When a VoIP connection activity transitions between “on” and “off” or (b) when the amount of VoIP packets that cannot be served using the current SPS uplink grant size exceeds N_{packet}. When this condition occurs, the ReNB 704 in block 1008 transmits an updated SPS uplink grant size before the period has ended. The DeNB 402 can also restrict the ReNB 704 from sending such a feedback too frequently by enforcing a minimum time interval between two consecutive feedbacks.

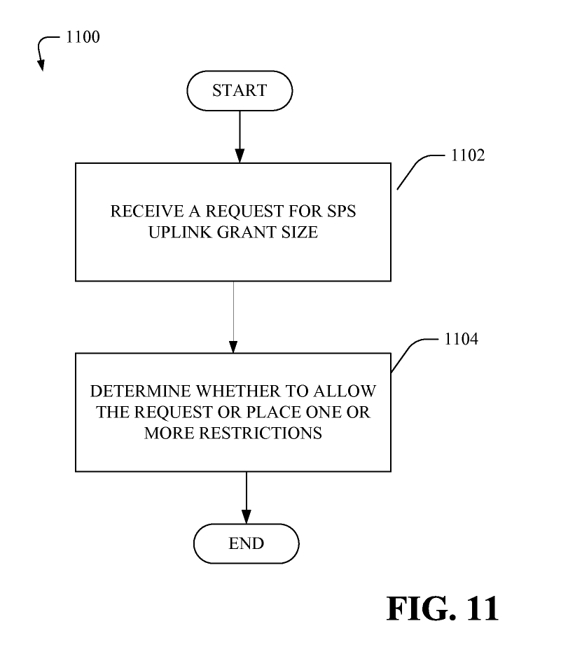

Referring to FIG. 11, a methodology 1100 provides a solution according to another aspect for managing uplink grants of SPS operation for multiple VoIP connection. In block 1102, the DeNB 702 receives a request for SPS uplink grant size. In block 1004, DeNB 702 determines whether to allow the request or place one or more restrictions.

The DeNB 702 provides the ReNB 704 the required SPS uplink grant size advertised by the ReNB 704 or if the data rates of different VoIP connections are the same, the DeNB 702 determines the SPS uplink grant size by using the following equation:

UL_Grant_Bytes_Precise=Number of uplink VoIP connections that are at the “on” state×Average number of bytes generated by a single VoIP call at the “on” state within a grant interval.

The SPS uplink grant size can be set slightly larger than “UL_Grant_Bytes_Precise”, so that a lower PDCCH signaling overhead introduced by VoIP packets not served by SPS can be achieved.

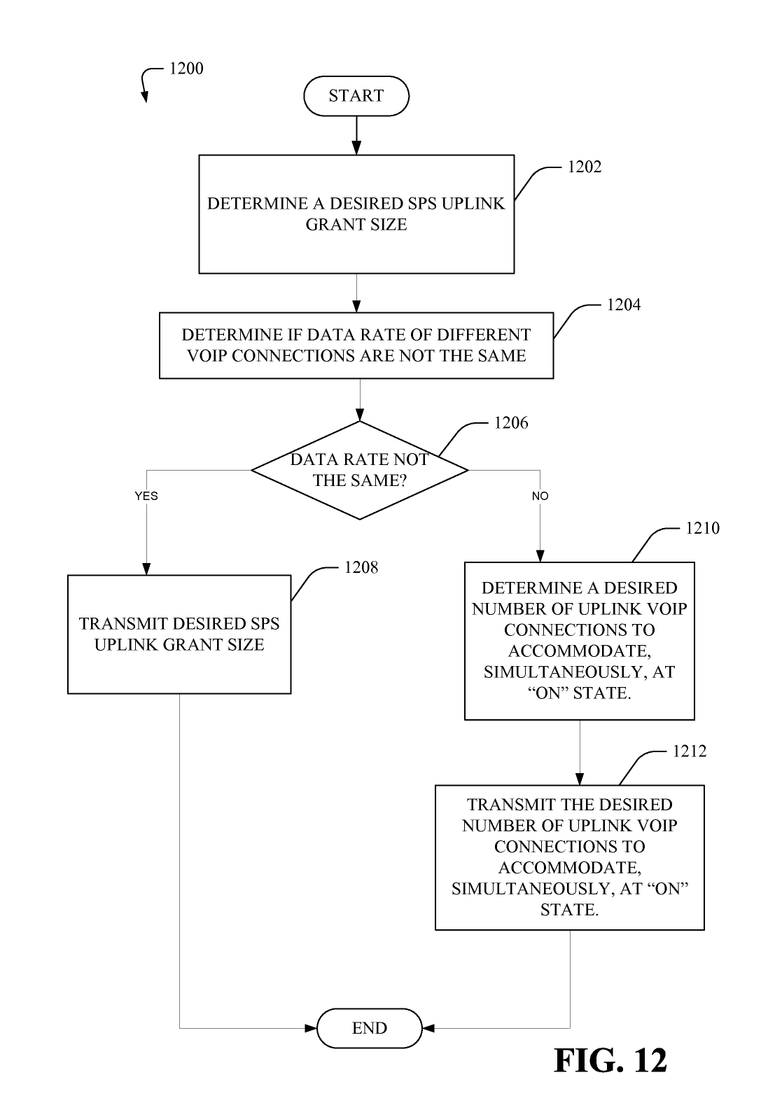

Referring to FIG. 12, a methodology 1200 provides a solution according to another aspect for managing uplink grants of SPS operation for multiple VoIP connection. In block 1202, the ReNB 704 determines a desired SPS uplink grant size. At block 1203, ReNB 704 determines if the data rate for different VoIP connection are not the same. If at block 1206, it is determined that data rate are not the same, then at block 1208, transmit the determined desired SPS uplink grant size. Otherwise, determine at 1210 desired number uplink VoIP connection to accommodate, concurrently, at “on” state and block 1212 transmit the desired number uplink VoIP connection to accommodate, concurrently, at “on” state. This decision can be made based on (a) number of VoIP connections or (b) number of VoIP connections that are at the “on” state. The decision process can take place under any of following conditions: (a) when a VoIP connection activity transitions between “on” and “off”; (b) once every T_{adjust} seconds; or (c) when the amount of VoIP packets that cannot be served using the current SPS uplink grant size exceeds N_{packet}.

The following methods can be used for a ReNB 704 making the above decision. The desired SPS uplink grant size is set such that, based on the number of VoIP connections and the number of VoIP connections currently at the on state, the probability that the number of “on” state VoIP connections exceeds the desired number at any point in time within the next T_{adjust} seconds is less than P_{inadequate}.

Note that this calculation can be done using the curves provided in FIG. 5 or using the following equations:

$${P}^{( 0 )} = [ {p}_{1}^{( 0 )} , {p}_{2}^{( 0 )} , … , {p}_{i}^{( 0 )} , … , {p}_{N}^{( 0 )} ] , {p}_{i}^{( 0 )} = 1 , \\ if i = {s}_{initial} ; o . w . , {p}_{i}^{( 0 )} = 0$$

$$A = [ {a}_{ij} ] , {a}_{ij} = \{ \begin{matrix}( 1 - {e}^{- ( N - i ) λ ( \frac{T}{K} )} ) {e}^{- iμ ( \frac{T}{K} )} , & if i = j - 1 \\ ( 1 - {e}^{- iμ ( \frac{T}{K} )} ) {e}^{- ( N - i ) λ ( \frac{T}{K} )} , & if i = j + 1 \\ 1 - ( 1 - {e}^{- ( N - i ) λ ( \frac{T}{K} )} ) {e}^{- iμ ( \frac{T}{K} )} - ( 1 - {e}^{- iμ ( \frac{T}{K} )} ) {e}^{- ( N - i ) λ ( \frac{T}{K} )} , & i = j \\ 0 , & o . w .\end{matrix} \\ {P}^{( k )} = {P}^{( 0 )} {A}^{k} \\ P ( T ) = \frac{1}{K} {\sum }_{k = 0}^{K} {P}^{( k )}$$

Where P⁽⁰⁾ denotes the initial probability distribution at the initial state; sᵢₙᵢₜᵢₐₗ denotes the number of uplink VoIP connections that are at the “on” state at the initial state; N denotes the number of uplink VoIP connections; T denotes the observation window; K denotes the number of evenly distributed points in the observation window; A denotes the state transition probability from one observation point to the next; P^{(k)} denotes the probability distribution at the k-th observation point; P(T) denotes the probability distribution of the number of VoIP calls that are at the on state at any point in time within an observation window.

When the data rates of different VoIP connections are the same (block 1206), the SPS size can be set to the data rate of a VoIP connection times a targeted number, where the probability that the number of “on” state VoIP connections at any moment in time within the observation window is larger than that targeted number is less than a certain value. When the data rates of different VoIP connections are not the same in block 1206, the DeNB 402 can set the SPS size to be equal to the targeted number of “on” state VoIP connections times the average SPS size required by one VoIP connection among all established VoIP connections. The desired number of uplink VoIP connections to be accommodated simultaneously at their “on” state is set slightly larger than the number of uplink VoIP connections by a fixed amount.

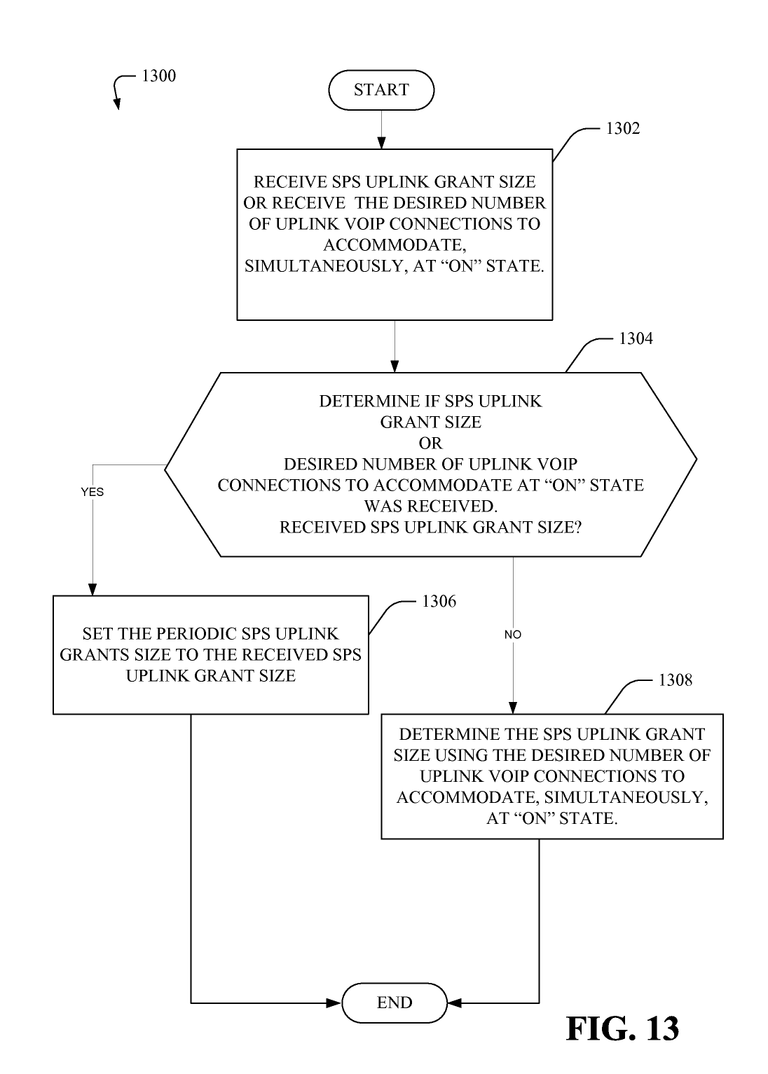

Referring to FIG. 13, a methodology 1300 provides a solution according to another aspect for managing uplink grants of SPS operation for multiple VoIP connection. Block 1302 receives either uplink grant size or the desired number of uplink VoIP connections to accommodate, concurrently, at “on” state. At block 1304, DeNB 702 determines whether the uplink grant size or the desired number of uplink VoIP connections to accommodate, concurrently, at “on” state was received. If uplink grant size was received, then at block 1306, DeNB 702 sets the periodic SPS uplink grant sized to the received SPS uplink grant size. Otherwise, at 1308 the DeNB 702 determines SPS uplink grant size using the received desired number of uplink VoIP connections to accommodate, concurrently, at “on” state.

In an aspect, a feedback mechanism is used to communicate between ReNB 704 and DeNB 702 to carry out the above methodologies. The feedback mechanism from the ReNB 704 to the DeNB 702 facilitates dynamic adjustment of the SPS uplink grant size. In one aspect, the dynamic adjustment takes the form of the number of uplink VoIP connections served by the ReNB 704 and the upper bound of the uplink grants or the change on the upper bound of uplink grants can be specified by a new Radio Resource Control (RRC) Information Element (IE), “SPSFeedback” IE. The IE can be included in a new Radio Resource Control (RRC) message, namely “RRCSPSFeedback” or the existing RRC message, “RRCConnectionReestablishmentRequest”. Either one of these two messages should be sent by the ReNB 704 to the DeNB 702 when the ReNB 704 intends to send the “SPSFeedback” IE to the DeNB 702. Since this feedback takes place at the call arrival and departure level, the frequency of sending such a feedback is low. Hence, sending the information at the RRC level will both be effective and appropriate in its scope.

In another aspect, the dynamic adjustment takes the form of the current required SPS uplink grant size, or equivalently the number of uplink VoIP connections that are at the on state, and the desired SPS uplink grant size, or equivalently the number of uplink VoIP connections to be accommodated simultaneously at their “on” state can be specified in any of the following IEs or messages:
Buffer Status Report (BSR): Additional bits can be introduced to identify whether the BSR is sent for SPS; or one of the reserved LCID can be used in the MAC PDU sub-header for the SPS purpose.
SPS MAC Control Element (MAC CE): The SPS MAC CE can be sent via the LCID of the Common Control Channel (CCCH) or Dedicated Control Channel (DCCH), or one of the reserved LCID.

The DeNB 702 can advertise the minimum time interval allowed between two consecutive feedbacks in an additional field in the “RadioResourceConfigDedicated” IE. In this manner, the ReNB 704 may use this information to help decide a desired SPS uplink grant size, or equivalently a desired number of uplink VoIP connections to be accommodated concurrently at their “on” state.

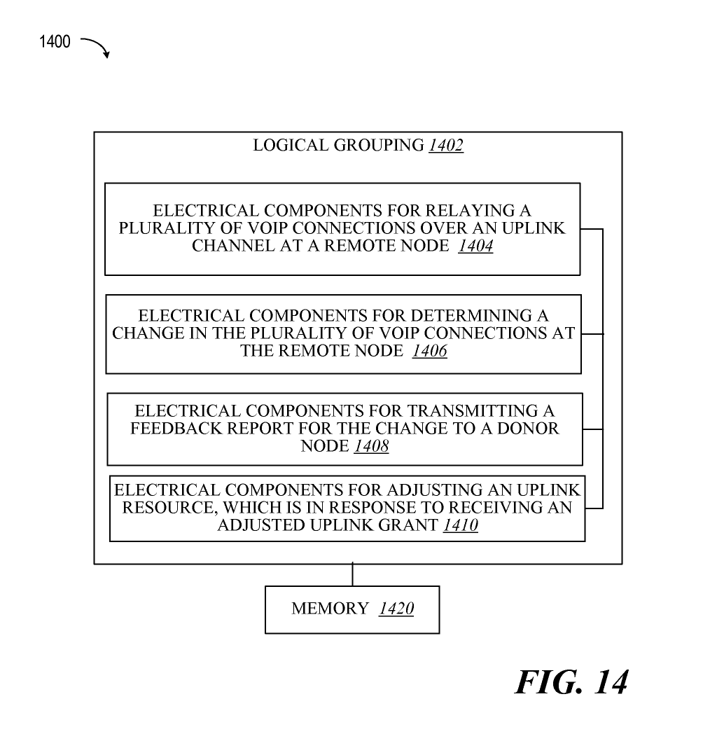

With reference to FIG. 14, illustrated is a system 1400 for dynamically adjusting SPS for VoIP. For example, system 1400 can reside at least partially within an ReNB. It is to be appreciated that system 1400 is represented as including functional blocks, which can be functional blocks that represent functions implemented by a computing platform, processor, software, or combination thereof (e.g., firmware). System 1400 includes a logical grouping 1402 of electrical components that can act in conjunction. For instance, logical grouping 1402 can include an electrical component for relaying a plurality of VoIP connections over an uplink channel, which in an exemplary aspect is at a remote node 1404. In addition, the logical grouping 1402 can include an electrical component for determining a change in the plurality of VoIP connections, which in an exemplary is at the remote node 1406. In addition, the logical grouping 1402 can include an electrical component for transmitting a feedback report for the change to a donor node 1408. Further, the logical grouping 1402 can include an electrical component for adjusting an uplink resource, which in an exemplary aspect is in response to receiving an adjusted uplink grant 1410. Additionally, system 1400 can include a memory 1420 that retains instructions for executing functions associated with electrical components 1404-1410. While shown as being external to memory 1420, it is to be understood that one or more of electrical components 1404-1410 can exist within memory 1420.

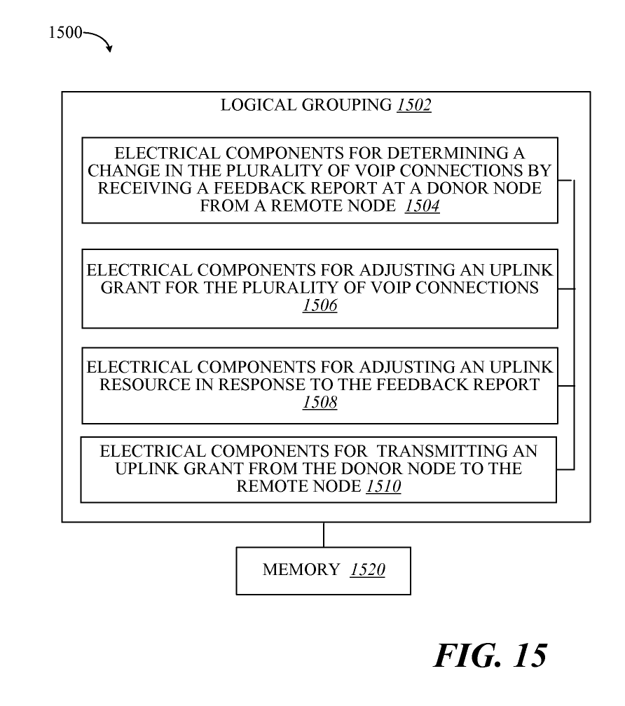

With reference to FIG. 15, illustrated is a system 1500 for dynamically adjusting SPS for VoIP. For example, system 1500 can reside at least partially within a DeNB. It is to be appreciated that system 1500 is represented as including functional blocks, which can be functional blocks that represent functions implemented by a computing platform, processor, software, or combination thereof (e.g., firmware). System 1500 includes a logical grouping 1502 of electrical components that can act in conjunction. For instance, the logical grouping 1502 can include an electrical component for determining a change in the plurality of VoIP connections, which an exemplary aspect is by receiving a feedback report at the donor node from the remote node 1504. Moreover, the logical grouping 1502 can include an electrical component for adjusting an uplink grant for the plurality of VoIP connections 1506. For instance, the logical grouping 1502 can include an electrical component for adjusting an uplink resource, which in an exemplary aspect is in response to the feedback report 1508. For instance, the logical grouping 1502 can include an electrical component for transmitting an uplink grant from the donor node to the remote node 1510. Additionally, system 1500 can include a memory 1520 that retains instructions for executing functions associated with electrical components 1504-1510. While shown as being external to memory 1520, it is to be understood that one or more of electrical components 1504-1510 can exist within memory 1520.

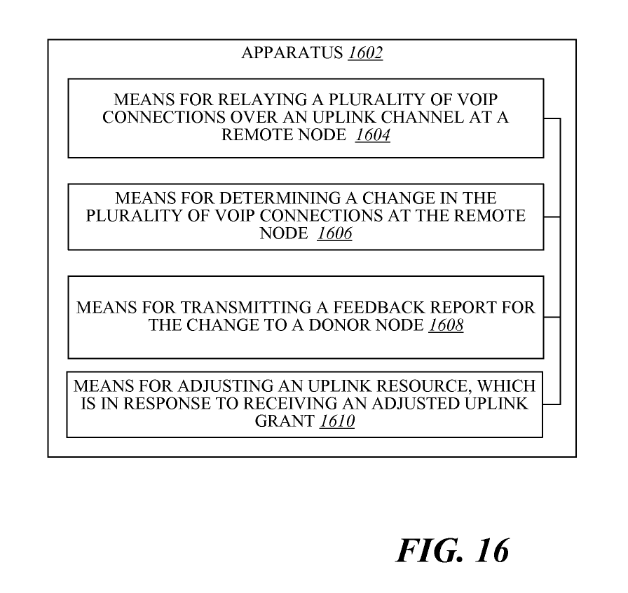

In FIG. 16, an apparatus 1602 is depicted for dynamically adjusting SPS for VoIP. Means 1604 are provided for relaying a plurality of VoIP connections over an uplink channel, which in an exemplary aspect is at a remote node. Means 1606 are provided for determining a change in the plurality of VoIP connections, which in an exemplary is at the remote node. Means 1608 are provided for transmitting a feedback report for the change to a donor node. Means 1610 are provided for adjusting an uplink resource, which in an exemplary aspect is in response to receiving an adjusted uplink grant.

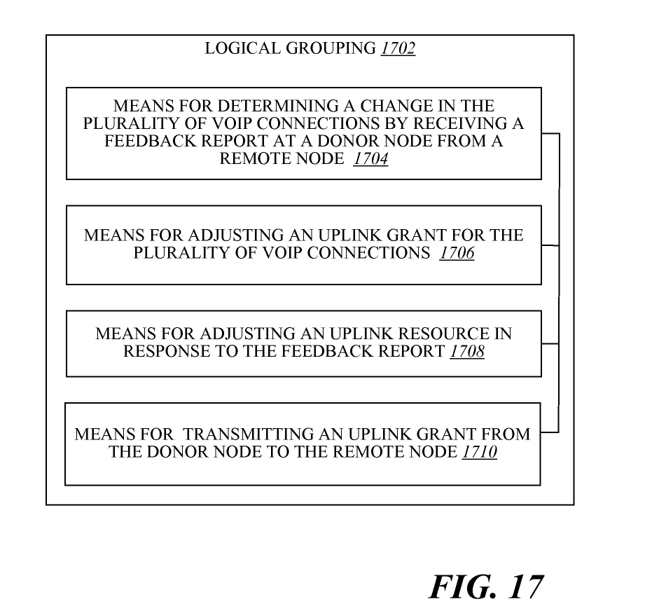

In FIG. 17, an apparatus 1702 is depicted for dynamically adjusting SPS for VoIP. Means 1704 are provided for determining a change in the plurality of VoIP connections, which an exemplary aspect is by receiving a feedback report at a donor node from a remote node. Means 1706 are provided for adjusting an uplink grant for the plurality of VoIP connections. Means 1708 are provided for adjusting an uplink resource, which in an exemplary aspect is in response to the feedback report. Means 1710 are provided for transmitting an uplink grant from the donor node to the remote node.

It is to be understood that the aspects described herein may be implemented by hardware, software, firmware or any combination thereof. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. An apparatus operable in a wireless communication system, the apparatus comprising:
means for determining number of VoIP connections;
means for determining if data rate for the VoIP connections are not the same; and
means for transmitting upper bounds of uplink grants required if the data rate for the VoIP connections are not the same.

2. The apparatus of claim 1, further comprising means for transmitting the number of VoIP connections.

3. The apparatus of claim 1, further comprising means for transmitting a new value representing current number of VoIP connections.

4. A method for adjusting semi-persistent scheduling (SPS) for Voice over Internet Protocol (VoIP); comprising:
determining number of VoIP connections;
determining if data rate for the VoIP connections are not the same; and
transmitting upper bounds of uplink grants required if the data rate for the VoIP connections are not the same.

5. The method of claim 4, further comprising transmitting the number of VoIP connections.

6. The method of claim 4, further comprising transmitting a new value representing current number of VoIP connections.

7. The method of claim 4, further comprising determining a fixed upper SPS uplink grant size to use.

8. The method of claim 7 wherein the following equation is employed to determine the upper SPS uplink grant size:
$${π}_{i} = {{π}_{0} ( \frac{λ}{μ} )}^{i} {\prod }_{j = 1}^{i} ( \frac{N - j + 1}{j} ) , i = 1 , 2 , … N$$
$${π}_{0} = 1 / ( 1 + {\sum }_{i = 1}^{N} {( \frac{λ}{μ} )}^{i} {\prod }_{j = 1}^{i} ( \frac{N - j + 1}{j} ) )$$
where πᵢ, i=0, 1, . . . , N, denotes steady state probability that number of uplink VoIP connections are at “on” state is equal to i; N denotes number of VoIP connections; 1/λ denotes average duration of an “off” interval for a VoIP activity; 1/μ denotes average duration of an “on” interval for the VoIP activity.

9. A computer program product for adjusting semi-persistent scheduling (SPS) for Voice over Internet Protocol (VoIP); comprising:
at least one computer readable storage medium storing computer executable instructions that, when executed by at least one processor, implement components that effect the following acts:
determine number of VoIP connections;
determine if data rate for the VoIP connections are not the same; and
transmit upper bounds of uplink grants required if the data rate for the VoIP connections are not the same.

10. An apparatus operable in a wireless communication system, the apparatus comprising:
means for determining desired SPS uplink grant size;
means for transmitting, periodically, the desired SPS uplink grant size;
means for monitoring number of VoIP calls and connections;
means for determining if conditions have changed that would require a change in current uplink grant size requirement; and
means for transmitting a new SPS uplink grant size prior to end of period.

11. A method for adjusting semi-persistent scheduling (SPS) for Voice over Internet Protocol (VoIP); comprising:
determining desired SPS uplink grant size;
transmitting, periodically, the desired SPS uplink grant size;
monitoring number of VoIP calls and connections;
determining if conditions have changed that would require a change in current uplink grant size requirement; and
transmitting a new SPS uplink grant size prior to end of period.

12. The method of claim 11 wherein SPS uplink grant size is determined as a function of number of VoIP connections currently supported.

13. The method of claim 11 wherein the uplink grant size is predetermined based on at least one of the following factors: geographical location, time of day or day of the week.

14. The method of claim 11 further comprising, when at least one new connection has been added during the period, transmitting an update before the period has expired.

15. The method of claim 14 further comprising monitoring VoIP calls and number of connections to determine if change in conditions would require a change in current uplink SPS grant size.

16. The method of claim 15 wherein the change in condition comprises at least one of: (a) when a VoIP connection activity transitions between “on” and “off” or (b) when amount of VoIP packets that cannot be served using current SPS uplink grant size exceeds number of packets (N_{packet}).

17. A computer program product for adjusting semi-persistent scheduling (SPS) for Voice over Internet Protocol (VoIP); comprising:
at least one computer readable storage medium storing computer executable instructions that, when executed by at least one processor, implement components that effect the following acts:
determine desired SPS uplink grant size;
transmit, periodically, the desired SPS uplink grant size;
monitor number of VoIP calls and connections;
determine if conditions have changed that would require a change in current uplink grant size requirement; and
transmit a new SPS uplink grant size prior to end of period.

18. An apparatus operable in a wireless communication system, the apparatus comprising:
means for determining desired SPS uplink grant size;
means for determining if data rate for the VoIP connections are not the same; and
means for transmitting the desired SPS uplink grant size if determined that data rate for the VoIP connections are not the same.

19. An apparatus operable in a wireless communication system, the apparatus comprising:
means for receiving number of VoIP connections;
means for receiving upper bounds of uplink grants required; and
means for determining a fixed upper uplink grant size.

20. A method for dynamically adjusting semi-persistent scheduling (SPS) for Voice over Internet Protocol (VoIP); comprising:
employing a processor executing computer executable instructions stored on a computer readable storage medium to implement following acts:
relaying a plurality of VoIP connections over an uplink channel;
determining change in the plurality of VoIP connections; and
adjusting an uplink grant for the plurality of VoIP connections.

21. The method of claim 20, further comprising adjusting the uplink grant for the plurality of VoIP connections in response to a predefined period of time having elapsed.

22. The method of claim 20, further comprising:
relaying the plurality of VoIP connections over the uplink channel by transmitting the plurality the VoIP connections at a remote node;
determining the change in the plurality of VoIP connections at the remote node;
transmitting a feedback report for the change to a donor node; and
adjusting an uplink resource in response to receiving an adjusted uplink grant.

23. The method of claim 22, further comprising determining the change in the plurality of VoIP connections by determining an aggregate traffic value for the plurality of VoIP connections over a period of time.

24. The method of claim 23, further comprising determining the aggregate traffic value at a remote node based at least in part upon a number of the plurality of VoIP connections.

25. The method of claim 24, further comprising transmitting the feedback report in response to a change in the number of the plurality of VoIP connections.

26. The method of claim 23, further comprising determining the aggregate traffic value at a remote node based at least in part upon a data rate respectively of the plurality of the plurality of VoIP connections.

27. The method of claim 26, further comprising transmitting the feedback report in response to a change in an aggregate data rate of the plurality of VoIP connections.

28. The method of claim 23, further comprising determining the aggregate traffic value at a remote node based at least in part upon a number of the plurality of VoIP connections that are in an ON state.

29. The method of claim 28, further comprising transmitting the feedback report in response to a change in the number of the plurality of VoIP connections.

30. The method of claim 23, further comprising transmitting the feedback report by transmitting a desired uplink grant size based upon the aggregate traffic value.

31. The method of claim 23, further comprising transmitting the feedback report by transmitting an upper bound based upon the aggregate traffic value.

32. The method of claim 31, further comprising transmitting the upper bound in response to a current uplink grant being below the upper bound.

33. The method of claim 20, further comprising:
relaying the plurality of VoIP connections over the uplink channel by receiving the plurality the VoIP connections at a donor node from a remote node;
determining the change in the plurality of VoIP connections by receiving a feedback report at the donor node from the remote node;
adjusting the uplink resource in response to the feedback report; and
transmitting an uplink grant for the uplink resource from the donor node to the remote node.

34. The method of claim 33, further comprising adjusting the uplink resource in response to the feedback report as a tradeoff between an uplink grant efficiency level and a control channel signaling overhead for VoIP packets not served by semi-persistent scheduling.

35. The method of claim 33, further comprising adjusting the uplink resource based upon a number of the plurality of VoIP connections.

36. The method of claim 33, further comprising adjusting the uplink resource based upon an aggregate data rate of the plurality of the plurality of VoIP connections.

37. The method of claim 33, further comprising adjusting the uplink resource based upon a number of the plurality of VoIP connections that are in an ON state.

38. The method of claim 33, further comprising adjusting the uplink resource based upon a product of a number of the plurality of VoIP connections that are in an On state and an average amount of data generated a single VoIP connection within a grant interval.

39. The method of claim 38, further comprising adjusting the uplink resource upward for lowering control channel signaling overhead for a VoIP connection not served by semi-persistent scheduling.

40. A computer program product for dynamically adjusting of semi-persistent scheduling (SPS) for Voice over Internet Protocol (VoIP); comprising:
at least one computer readable storage medium storing computer executable instructions that, when executed by at least one processor, implement components comprising:
a first set of codes for relaying a plurality of VoIP connections over an uplink channel;
a second set of codes for determining a change in the plurality of VoIP connections; and
a third set of codes for adjusting an uplink grant for the plurality of VoIP connections.

41. An apparatus for dynamically adjusting of semi-persistent scheduling (SPS) for Voice over Internet Protocol (VoIP); comprising:
at least one processor;
at least one computer readable storage medium storing computer executable instructions that, when executed by the at least one processor, implement components comprising:
means for relaying a plurality of VoIP connections over an uplink channel;
means for determining a change in the plurality of VoIP connections; and
means for adjusting an uplink grant for the plurality of VoIP connections.
